(19) United States
(12) Patent Application Publication
(10) Pub. No.: US 2018/0142635 A1
(43) Pub. Date: May 24, 2018

(54) SYSTEM AND METHOD OF PREVENTING SURGE OF VEHICLE

(71) Applicants: Hyundai Motor Company, Seoul (KR); Kia Motors Corporation, Seoul (KR)

(72) Inventor: Hyunwoo NOH, Gwacheon-si (KR)

(73) Assignees: Hyundai Motor Company, Seoul (KR); Kia Motors Corporation, Seoul (KR)

(21) Appl. No.: 15/609,630

(22) Filed: May 31, 2017

(30) Foreign Application Priority Data
Nov. 22, 2016 (KR) 10-2016-0155589

(51) Int. Cl. F02D 41/00; F01N 3/023; F02D 21/08

(52) U.S. Cl. CPC F02D 41/0055; F01N 3/023; F02D 2250/21; F02D 41/0077; F02D 2200/602; F02D 21/08

(57) ABSTRACT

A method and a system for preventing surge of a vehicle may include: determining whether an engine operation mode is a particulate filter regeneration mode or a catalyst desulfurization mode; determining, when the engine operation mode is the particulate filter regeneration mode or the catalyst desulfurization mode, a torque change; determining whether the torque change is smaller than a predetermined value; determining, when the torque change is smaller than the predetermined value, whether an intake pressure is higher than an exhaust pressure by at least a predetermined pressure; and opening, when the intake pressure is higher than the exhaust pressure by at least the predetermined pressure, an exhaust gas recirculation (EGR) valve and a throttle valve.

### CROSS-REFERENCE(S) TO RELATED APPLICATIONS

The present application claims priority to Korean Patent Application No. 10-2016-0155589 filed on Nov. 22, 2016, the entire contents of which are incorporated herein for all purposes by this reference.

### BACKGROUND OF THE INVENTION

### Field of the Invention

The present invention relates to a method and a system for preventing surge of a vehicle. More particularly, the present invention relates to a method and a system for preventing surge of a vehicle that can prevent occurrence of surge in full tip-out or partial tip-out during regenerating a particulate filter or desulfurizing a catalyst.

### Description of Related Art

Increased exhaust gas due to an explosive increase in the number vehicles operated daily causes environment pollutants to be very serious problem, and therefore abnormal climate changes are being more common due to global warming. To prevent environment pollution from the exhaust gas of vehicles, strict regulations for restricting the exhaust gas of the vehicles are being established in every country. Particularly, exhaust gas regulations to vehicles provided with a diesel engine have become more and more strict.

To enhance performance and meet exhaust gas regulations, common rail technique where high-pressure fuel is directly injected into a combustion chamber is applied to vehicles.

In addition, turbo charger systems are applied to vehicles. According to the turbo charger systems, air flow rate is increased by forcibly feeding air flowing through an air cleaner into the combustion chamber of the engine, thereby improving engine output and reducing exhaust gas emissions.

Typically, intake and exhaust systems of small commercial vehicles having a diesel engine are longer and more complex than those of the passenger cars or vans due to the vehicle's shape.

Therefore, due to the size, it is very difficult to match pressure changes at an upstream and downstream location of the turbo charger in small commercial vehicles. In a case of tip-out of an accelerator pedal, an engine RPM drops quickly and air supercharged by the turbo charger cannot be supplied into the combustion chamber. Therefore, the intake pressure may become higher than the exhaust pressure of the combustion chamber in a moment. At the present time, partial pressure of the air is generated at a compressor of the turbo charger, and the air supercharged by the compressor flows backward to an inlet side, causing an air temperature to rise, commonly known as a ‘surge’.

Meanwhile, the vehicle is provided with a particulate filter for trapping particulate matter contained in the exhaust gas and a catalyst for purifying noxious material contained in the exhaust gas. When an amount of particulate matter trapped in the particulate filter is greater than a predetermined amount, a controller of the vehicle burns and removes the trapped particulate matter, commonly known as a ‘regeneration of particulate filter’. Further, when the sulfur content poisoned in the catalyst is greater than a predetermined amount, the controller performs desulfurization of the catalyst.

When full tip-out or partial tip-out occurs while the particulate filter is regenerated or the catalyst is desulfurized, a throttle valve is closed to meet a target air amount and air flow rate passing through the compressor of the turbo charger decreases; therefore, surge occurs. At the present time, when an exhaust gas recirculation (EGR) valve is opened to prevent surge, various valves or coolers provided in the intake and exhaust systems may be damaged due to the increased amount of total hydrocarbon (THC). Therefore, there are needs for preventing surge during regenerating the particulate filter or desulfurizing the catalyst.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method and a system for preventing surge of a vehicle, and the system having advantages of preventing an occurrence of surge without additional devices in full tip-out or partial tip-out during regenerating a particulate filter or desulfurizing a catalyst.

A method of preventing surge of a vehicle according to an exemplary embodiment of the present invention may include: determining whether an engine operation mode is a particulate filter regeneration mode or a catalyst desulfurization mode; determining, when the engine operation mode is the particulate filter regeneration mode or the catalyst desulfurization mode, a torque change; determining whether the torque change is smaller than a predetermined value; determining, when the torque change is smaller than the predetermined value, whether an intake pressure is higher than an exhaust pressure by at least a predetermined pressure; and opening, when the intake pressure is higher than the exhaust pressure by at least the predetermined pressure, an exhaust gas recirculation (EGR) valve and a throttle valve.

The torque change may be determined from a displacement change of an accelerator pedal.

Each of the EGR valve and the throttle valve may be opened by a predetermined value for a predetermined time.

In one aspect, the EGR valve and the throttle valve may be simultaneously opened or closed.

In another aspect, the EGR valve may be opened after the throttle valve is opened, and the throttle valve and the EGR valve may be simultaneously closed.

A system for preventing surge of a vehicle according to another exemplary embodiment of the present invention may include: an engine including an intake manifold receiving air and an exhaust manifold discharging exhaust gas; a throttle valve configured to control air flow supplied to the intake manifold; an exhaust gas recirculation (EGR) valve recirculating a portion of the exhaust gas back into the intake manifold and configured to control amount of the recirculated exhaust gas; and a controller controlling the opening amount of the throttle valve and the EGR valve, wherein the controller is configured to open the EGR valve and the throttle valve when an engine operation mode is a particulate filter regeneration mode or a catalyst desulfurization mode, a torque change is smaller than a predetermined value, and an intake pressure is higher than the exhaust pressure by at least a predetermined pressure.

The controller may be configured to determine the torque change from a displacement change of an accelerator pedal.

The controller may be configured to open both of the EGR valve and the throttle valve by a predetermined value for a predetermined time.

In one aspect, the controller may open or close the EGR valve and the throttle valve simultaneously.

In another aspect, the controller may open the EGR valve after opening the throttle valve, and close the throttle valve and the EGR valve simultaneously.

According to an exemplary embodiment of the present invention, an occurrence of surge may be prevented without additional particulate devices even though tip-out occurs during regenerating a particulate filter or desulfurizing a catalyst.

Since both of the throttle valve and the EGR valve are opened, intake air is discharged as an exhaust gas without combustion. Therefore, damage of various valves or coolers provided in the intake and exhaust systems may be prevented.

Further, since both of the throttle valve and the EGR valve are opened only when an intake pressure is higher than an exhaust pressure, the intake air is discharged to an exhaust pipe through the EGR valve. In the present process, soot adhered to an EGR path and valves or coolers mounted thereon may be removed.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a system for preventing surge of a vehicle according to an exemplary embodiment of the present invention.

FIG. 2 is a block diagram illustrating the inputs and outputs of a controller in a system for preventing surge of a vehicle according to an exemplary embodiment of the present invention.

FIG. 3 is a flowchart of a method of preventing surge of a vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is intended to cover not only the exemplary embodiments, but also various alternatives, modifications, equivalents and other embodiments, which may be included within the spirit and scope of the invention as defined by the appended claims.

Parts which are not related with the description are omitted for clearly describing the exemplary embodiments of the present invention and like reference numerals refer to like or similar elements throughout the specification.

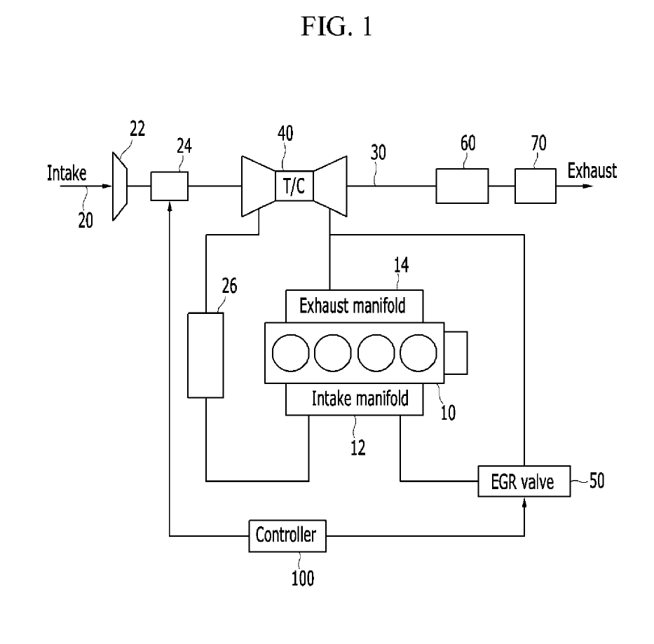

FIG. 1 is a schematic diagram of a system for preventing surge of a vehicle according to an exemplary embodiment of the present invention.

As shown in FIG. 1, a system for preventing surge of a vehicle according to an exemplary embodiment of the present invention includes an engine 10, a turbo charger 40, an exhaust gas recirculation (EGR) valve 50, and a controller 100.

The engine 10 burns a mixture of fuel and air to convert chemical energy into mechanical energy.

The engine 10 includes an intake manifold 12, and the intake manifold 12 is connected to an intake pipe 20 to receive air. Here, it is to be understood that the intake pipe 20 includes all the pipes, hoses, and ducts connected to the intake manifold 12 to supply the air to the intake manifold 12. A filter 22 and a throttle valve 24 are mounted at the intake pipe 20.

The filter 22 filters materials contained in the air supplied through the intake pipe 20.

The throttle valve 24 controls an amount of the air supplied through the intake pipe 20. The amount of the air is determined depending on an opening amount of the throttle valve 24, and the opening amount of the throttle valve 24 is expressed as a percentage. For example, when the opening amount of the throttle valve 24 is 100% the throttle valve 24 is fully opened, and when the opening amount of the throttle valve 24 is 0% the throttle valve 24 is completely closed.

The engine 10 includes an exhaust manifold 14, and an exhaust gas generated in combustion process is gathered in the exhaust manifold 14 and then is discharged to the external of the engine 10. The exhaust manifold 14 is connected to an exhaust pipe 30 to discharge the exhaust gas to the external of the vehicle. Here, it is to be understood that the exhaust pipe 30 includes all the pipes, hoses, and ducts connected to the exhaust manifold 14 to discharge the exhaust gas to the external of the vehicle. A particulate filter 60 and a catalyst 70 are mounted at the exhaust pipe 30.

The particulate filter 60 traps particulate matter contained in the exhaust gas. Typically, the particulate filter 60 includes a plurality of inlet channels and outlet channels. A first end portion of the inlet channel is opened and a second end portion of the inlet channel is blocked wherein the exhaust gas flows into the inlet channel. In addition, a first end portion of the outlet channel is blocked and a second end portion of the outlet channel is opened wherein the exhaust gas is discharged from the particulate filter 60. The exhaust gas flowing into the particulate filter 60 through the inlet channel flows to the outlet channel through a porous wall separating the inlet channel from the outlet channel, and then is discharged from the particulate filter 60 through the outlet channel. While the exhaust gas passes through the porous wall, the particulate matter contained in the exhaust gas is trapped.

Meanwhile, a pressure difference detector or is mounted at the exhaust pipe 30. The pressure difference detector is configured to detect a pressure difference between an upstream and a downstream location of the particulate filter 60 and transmits a signal corresponding thereto to the controller 100. The controller 100, when the pressure difference detected by the pressure difference detector is greater than or equal to a predetermined pressure, is controlled to regenerate the particulate filter 60. In the present case, the particulate matter trapped in the particulate filter 60 may be burnt by post-injecting the fuel by an injector.

The catalyst 70 is mounted at the exhaust pipe 30 downstream of the particulate filter 60 and purifies the noxious material (HC, CO, NOₓ, etc.) contained in the exhaust gas. When the catalyst 70 purifies nitrogen oxide, the catalyst 70 includes base material. In the present case, sulfur oxide contained in the exhaust gas can be adsorbed in the catalyst 70. As the sulfur oxide is adsorbed in the catalyst 70, purifying capacity of the nitrogen oxide can be deteriorated. Therefore, when an amount of the sulfur adsorbed in the catalyst 70 is greater than or equal to a predetermined amount, the sulfur oxide should be removed by raising a temperature of the exhaust gas. The present process is called desulfurization of the catalyst 70. Generally, desulfurization of the catalyst 70 is performed after regeneration of the particulate filter 60. According to an exemplary embodiment of the present invention, the catalyst 70 may be, but is not limited to, a selective catalytic reduction (SCR) catalyst.

In addition, a position of the catalyst 70 at the exhaust pipe 30 may be changed according to a type of the catalyst 70. For example, when the catalyst 70 is a lean NOₓ trap (LNT) catalyst, the catalyst 70 may be mounted at the exhaust pipe 30 upstream of the particulate filter 60. Therefore, the position of the catalyst 70 cannot be limited to a position exemplified in the present exemplary embodiment.

The turbo charger 40 supercharges intake air using the energy of the exhaust gas and includes a turbine and a compressor.

The turbine is mounted at the exhaust pipe 30 and is rotated by the exhaust gas.

The compressor is connected to the turbine through a shaft to be rotated with the turbine. The compressor is mounted at the intake pipe 20 and supercharges the intake air. That is, when the turbine is rotated by the exhaust gas, the compressor connected to the turbine is also rotated to increase an amount of the intake air.

The EGR valve 50 is mounted between the exhaust pipe 30 and the intake manifold 12 and configured to control an amount of the exhaust gas recirculated to the intake manifold 12. The amount of the recirculated exhaust gas is determined depending on an opening amount of the EGR valve 50, and the opening amount of the EGR valve 50 is expressed as a percentage. For example, when the opening amount of the EGR valve 50 is 100% the EGR valve 50 is fully opened, and when the opening amount of the EGR valve 50 is 0% the EGR valve 50 is completely closed. A position of the EGR valve 50 illustrated in FIG. 1 is one example and can be changed as the design demands. Therefore, the EGR valve 50 indicates all the valves that can control the amount of the exhaust gas recirculated to the intake manifold 12.

The controller 100 is configured to control the opening amounts of the throttle valve 24 and the EGR valve 50 according to an operation state of the engine 10. The controller 100 may be implemented by at least one processor operated by a predetermined program, and the predetermined program may be programmed to perform each step of a method of preventing surge of a vehicle according to an exemplary embodiment of the present invention.

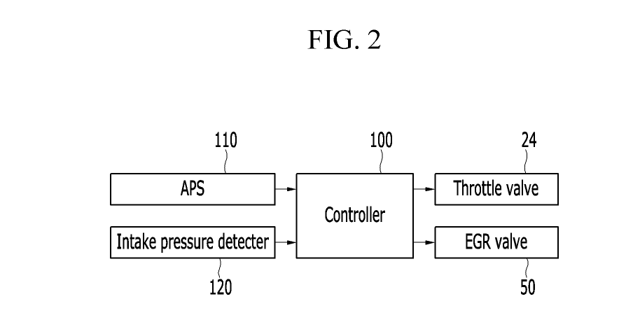

FIG. 2 is a block diagram illustrating the inputs and outputs of a controller in a system for preventing surge of a vehicle according to an exemplary embodiment of the present invention.

As shown in FIG. 2, the system for preventing surge of a vehicle according to the exemplary embodiment of the present invention further includes an accelerator position sensor (APS) 110 and an intake pressure detector 120.

The accelerator position sensor 110 detects a position or a displacement of an accelerator pedal (i.e., pushing amount of the accelerator pedal), and transmits a signal corresponding thereto to the controller 100. The controller 100 can control the opening amount of the throttle valve 24 according to the position of the accelerator pedal and operating state of the engine 100. In addition, the controller 100 can determine a torque change based on a displacement change of the accelerator pedal.

The intake pressure detector 120 is mounted at a suitable position in the intake manifold 12 or the intake pipe 20, detects the intake pressure, and transmits a signal corresponding thereto to the controller 100. The controller 100 can determine the amount of the intake air based on the detected value by the intake pressure detector 120.

The controller 100 is electrically connected to the accelerator position sensor 110 and the intake pressure detector 120, and controls the opening amounts of the throttle valve 24 and the EGR valve 50 to perform the method of preventing surge according to the exemplary embodiment of the present invention based on the detected values of the detectors.

For ease of description, a minimum number of detectors are illustrated in FIG. 2, and detectors other than the detectors illustrated in FIG. 2 may be mounted at the vehicle.

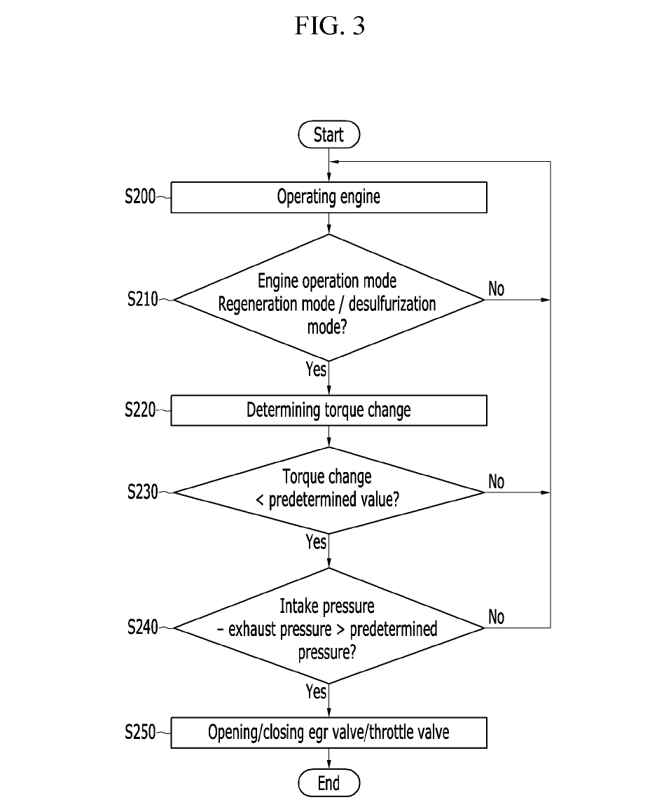

FIG. 3 is a flowchart of a method of preventing surge of a vehicle according to an exemplary embodiment of the present invention.

As shown in FIG. 3, the method of preventing surge of a vehicle according to the exemplary embodiment of the present invention is performed while the engine 10 is operated at step S200. That is, when the engine 10 is operated, the controller 100 determines whether an engine operation mode is a particulate filter regeneration mode or a desulfurization mode (particularly, a desulfurization heating mode) at step S210. When the particulate filter 60 begins to be regenerated or the catalyst 70 begins to be desulfurized, a signal for informing that the engine operation mode is the particulate filter regeneration mode or the desulfurization mode is input to the controller 100. In the present case, the controller 100 controls the regeneration of the particulate filter 60 or desulfurization of the catalyst 70 based on the signal. Therefore, the controller 100 checks whether the signal is input.

When the engine operation mode is not the particulate filter regeneration mode or the desulfurization mode at the step S210, the method returns to the step S200.

When the engine operation mode is the particulate filter regeneration mode or the desulfurization mode at the step S210, the controller 100 determines the torque change at step S220. As described above, the torque change may be, but is not limited to, determined from the displacement change of the accelerator pedal.

After that, the controller 100 determines whether the torque change is smaller than a predetermined value at step S230. That is, the controller 100 determines whether tip-in (action that foot pushing the accelerator pedal is taken off the accelerator pedal fully or a little) occurs. Here, the predetermined value may be, but not limited to, approximately−60 N·m/sec to−200 N·m/sec. The step S230 is performed to determine whether the tip-in occurs and the occurring tip-in causes the surge.

When the torque change is greater than or equal to the predetermined value (because of the torque change at the tip-in, absolute value of the torque change reduces) at the step S230, the method returns to the step S200.

When the torque change is smaller than the predetermined value (because of the torque change at the tip-in, absolute value of the torque change increases) at the step S230, the controller 100 determines whether a value obtained by subtracting the exhaust pressure from the intake pressure is higher than a predetermined pressure at step S240. As described above, the intake pressure may be, but not limited to, detected by the intake pressure detector 120. In addition, the exhaust pressure may be determined based on a vane angle of a turbine, a turbine speed, temperature or pressure at a turbine inlet, temperature or pressure at a turbine outlet, etc. However, determination of the exhaust pressure is not limited to the above. An additional pressure detector may be mounted at an inlet side of the turbine to detect the exhaust pressure. Here, the predetermined pressure may be, but not limited to, 0 to 500 hPa.

When the value obtained by subtracting the exhaust pressure from the intake pressure is lower than or equal to the predetermined pressure at the step S240, the method returns to the step S200.

When the value obtained by subtracting the exhaust pressure from the intake pressure is higher than the predetermined pressure at the step S240, the controller 100 determines that surge can occur. Therefore, the controller 100 opens the throttle valve 24 and the EGR valve 50. Typically, since various valves and coolers may be damaged by THC (total HC) contained in the exhaust gas in the particulate filter regeneration mode or the desulfurization mode, both of the throttle valve 24 and the EGR valve 50 are closed. According to the exemplary embodiment of the present invention, however, the intake pressure is higher than the exhaust pressure wherein fresh air flows into the exhaust system and lowers the intake pressure. Since the exhaust gas containing the THC does not flow in the intake manifold 12, various valves and coolers are not damaged. Resultantly, according to the exemplary embodiment of the present invention, the throttle valve 24 and the EGR valve 50 are opened only when the intake pressure is higher than the exhaust pressure.

The controller 100 opens the throttle valve 24 by a predetermined opening amount of the throttle valve 24 for a predetermined opening time of the throttle valve 24, and opens the EGR valve 50 by a predetermined opening amount of the EGR valve 50 for a predetermined opening time of the EGR valve 50. For example, the predetermined opening amount of the throttle valve 24 may be 90% to 100%, the predetermined opening amount of the EGR valve 50 may be 30% to 80%, and both of the predetermined opening time of the throttle valve 24 and the predetermined opening time of the EGR valve 50 may be 0.5 sec to 1 sec. In addition, at least a portion of an opening duration of the throttle valve 24 and an opening duration of the EGR valve 50 may be overlapped with each other. For example, the controller 100 may open or close the throttle valve 24 and the EGR valve 50 simultaneously. In another example, the EGR valve 50 may be opened after the throttle valve 24 is opened, and the throttle valve 24 and the EGR valve 50 may be simultaneously closed. In the present case, since the intake air flows into the exhaust pipe 30 through the EGR valve 50, the intake pressure is lowered to prevent surge. In addition, since the intake air flows into the exhaust pipe 30 without combustion, gas flowing through the exhaust pipe 30 does not contain HC. Therefore, damage of various valves or coolers provided in intake and exhaust systems may be prevented.

In addition, since the throttle valve 24 and the EGR valve 50 are opened only when the intake pressure is higher than the exhaust pressure according to the exemplary embodiment of the present invention, the intake air is discharged into the exhaust pipe 30 through the EGR valve 50. In the present process, soot adhered to an EGR path and valves or coolers mounted thereon flows to the exhaust pipe 30 together with the intake air. The soot may be trapped by the particulate filter 60 and be removed in regeneration.

After that, the controller 100 ends the method of preventing surge according to the exemplary embodiment of the present invention. Therefore, the controller 100 controls the throttle valve 24 and the EGR valve 50 in the particulate filter regeneration mode or the desulfurization mode according to a predetermined logic. The predetermined logic may be a particulate filter regeneration logic or a desulfurization logic set according to conventional arts.

For convenience in explanation and accurate definition in the appended claims, the terms “upper”, “lower”, “internal”, “outer”, “up”, “down”, “upwards”, “downwards”, “front”, “rear”, “back”, “inside”, “outside”, “inwardly”, “outwardly”, “internal”, “external”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of preventing surge of a vehicle comprising:
determining whether an engine operation mode is a particulate filter regeneration mode or a catalyst desulfurization mode;
determining, when the engine operation mode is the particulate filter regeneration mode or the catalyst desulfurization mode, a torque change;
determining whether the torque change is smaller than a predetermined value;
determining, when the torque change is smaller than the predetermined value, whether an intake pressure is higher than an exhaust pressure by at least a predetermined pressure; and
opening, when the intake pressure is higher than the exhaust pressure by at least the predetermined pressure, an exhaust gas recirculation (EGR) valve and a throttle valve.

2. The method of claim 1, wherein the torque change is determined from a displacement change of an accelerator pedal.

3. The method of claim 1, wherein each of the EGR valve and the throttle valve is configured to be opened by a predetermined value for a predetermined time.

4. The method of claim 3, wherein the EGR valve and the throttle valve are configured to be simultaneously opened or closed.

5. The method of claim 3, wherein the EGR valve is configured to be opened after the throttle valve is opened, and the throttle valve and the EGR valve are configured to be simultaneously closed.

6. A system for preventing surge of a vehicle comprising:
an engine including an intake manifold receiving air and an exhaust manifold discharging exhaust gas;
a throttle valve configured to control air amount supplied to the intake manifold;
an exhaust gas recirculation (EGR) valve recirculating a portion of the exhaust gas back into the intake manifold and configured to control amount of the recirculated exhaust gas; and
a controller configured for controlling opening amount of the throttle valve and the EGR valve,
wherein the controller is configured to open the EGR valve and the throttle valve when an engine operation mode is a particulate filter regeneration mode or a catalyst desulfurization mode, a torque change is smaller than a predetermined value, and an intake pressure is higher than an exhaust pressure by at least a predetermined pressure.

7. The system of claim 6, wherein the controller is configured to determine the torque change from a displacement change of an accelerator pedal.

8. The system of claim 6, wherein the controller opens both of the EGR valve and the throttle valve by a predetermined value for a predetermined time.

9. The system of claim 8, wherein the controller is configured to open or close the EGR valve and the throttle valve simultaneously.

10. The system of claim 8, wherein the controller is configured to open the EGR valve after opening the throttle valve, and is configured to close the throttle valve and the EGR valve simultaneously.
